(19) United States
(12) Patent Application Publication
(10) Pub. No.: US 2004/0105169 A1
(43) Pub. Date: Jun. 3, 2004

(54) Object lens system and optical pick-up apparatus

(75) Inventor: Mitsuhiro Togashi, Yokohama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/722,005

(22) Filed: Nov. 25, 2003

(30) Foreign Application Priority Data
Nov. 27, 2002 (JP) 2002-344032

(51) Int. Cl. G02B 3/02; G02B 13/18

(52) U.S. Cl. 359/719

(57) ABSTRACT

Disclosed herein is an object lens system, which miniaturizes the size of an optical pick-up apparatus while preventing influence resulting from a variation in the wavelength of a blue laser light irradiated onto an optical disc using optical parts with practical sizes, without miniaturizing the optical parts of the object lens system. The object lens system is arranged to face an optical disc, collect a light and irradiate the light onto the optical disc, and includes a direction changing means and a solid lens. The direction changing means changes a moving direction of an incident light to an orthogonal direction thereof, irradiates it onto the optical disc, and is provided with a hologram on one side surface thereof. The solid lens is disposed in front of the incident surface of the direction changing means.

### CROSS-REFERENCE TO RELATED APPLICATION

This application claims to benefit of Japanese Patent Application No. 2002-00344032, filed Nov. 27, 2002 in the Japanese Patent Office, the disclosure of which is incorporated herein by reference.

### BACKGROUND OF THE INVENTION

1. Field of the Invention

The present invention relates to an object lens system and optical pick-up apparatus.

2. Description of the Prior Art

An optical pick-up apparatus of an optical disc drive needs to be miniaturized to satisfy a trend toward the miniaturization of the optical disc drive. However, in a drive using a blue laser light that is a next generation optical disc drive, in the case where a wavelength used in the drive is shorter than that of an existing general optical disc drive, a Numerical Aperture (NA) of an object lens system needs to be high. Accordingly, a lens in which two lenses having different diameters are stacked should be used, so that the sizes of optical parts of the object lens system become great in an optical axis direction thereof, and therefore the miniaturization of the optical pick-up apparatus is difficult.

Additionally, it is considered that the object lens system is constructed to be slim by miniaturizing the two lenses. However, in this case, the lenses may be easily damaged and, therefore, the handling of the lenses is difficult. At the same time, it is considerably difficult to arrange the lenses with the optical axes thereof aligned with each other. Accordingly, the object lens system needs to be miniaturized using optical parts with practical sizes.

Meanwhile, it is possible to construct an object lens system using a single lens based on the study of optical properties thereof. However, in this case, the object lens system cannot deal with influence resulting from a variation in the wavelength of a blue laser light. That is, a semiconductor laser diode is used as a light source in an optical pick-up apparatus, but the wavelength of a blue laser light emitted from the semiconductor laser diode varies depending upon the variation in the temperature of the semiconductor laser diode. According to such a variation in the wavelength, the wave front aberration of the object lens system is changed, so that the object lens system cannot have stable performance.

Additionally, an optical pick-up apparatus for an optical disc is disclosed in detail in the following document.

(Patent Document 1)

Japanese Examined Patent Publication No. 10-208278

### SUMMARY OF THE INVENTION

Accordingly, the present invention has been made keeping in mind the above problems occurring in the prior art, and an object of the present invention is to provide an object lens system and optical pick-up apparatus, which can prevent influence resulting from a variation in the wavelength of a blue laser light irradiated onto an optical disc using optical parts with practical sizes, and miniaturize the size of the apparatus.

In order to accomplish the above object, the present invention provides the object lens system arranged to face an optical disc, collect a light and irradiate the light onto the optical disc, which includes a direction changing means for changing the moving direction of an incident light to the orthogonal direction thereof and emitting it onto the optical disc, a hologram disposed between the direction changing means and the optical disc, and a solid lens disposed in front of the direction changing means.

The direction changing means is a reflecting surface formed on the inclined surface of a triangular prism, and the hologram is formed on the emitting surface of the triangular prism.

The triangular prism is provided on the incident surface thereof with a second concave surface that causes the incident light to diverge in the direction orthogonal to the optical disc. The triangular prism is provided on the emitting surface thereof with a first concave surface that causes the diverging incident light to converge. The triangular prism is provided on the first concave surface thereof with the hologram.

The solid lens is a concave lens that is disposed in front of the incident surface of the direction changing means.

The hologram is formed of light transparent materials.

In order to accomplish the above object, the present invention provides the object lens system arranged to face an optical disc, collect a light and irradiate the light onto the optical disc, which includes a direction changing means for changing the moving direction of an incident light to the orthogonal direction thereof and emitting it onto the optical disc, a hologram unit disposed in front of the direction changing means and provided with a hologram, and a solid lens disposed between the direction changing means and the optical disc.

The direction changing means is a beam splitter.

The hologram is formed of light transparent materials.

In order to accomplish the above object, the present invention provides an optical pick-up apparatus provided with any of object lens systems described in the above description to emit a light onto the object lens system and detect the intensity of a reflected light obtained by an optical disc.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view showing the construction of a principal part (an object lens system) of an optical pick-up apparatus according to a first embodiment of the present invention;

FIGS. 2a to 2c are front and sectional views of a hologram according to the first embodiment of the present invention;

FIG. 3 is a front view showing the construction of a principal part (an object lens system) of an optical pick-up apparatus according to a second embodiment of the present invention;

FIG. 4 is a characteristic diagram (simulation result) showing the wavelength dependency of the front wave aberration of the object lens system according to the second embodiment of the present invention; and

FIG. 5 is a front view showing the construction of a principal part (an object lens system) of an optical pick-up apparatus according to a third embodiment of the present invention.

### DESCRIPTION OF THE PREFERRED EMBODIMENTS

Hereinafter, embodiments of an object lens system and optical pick-up apparatus will be described with reference to the attached drawings.

Reference should now be made to the drawings, in which the same reference numerals are used throughout the different drawings to designate the same or similar components.

First Embodiment

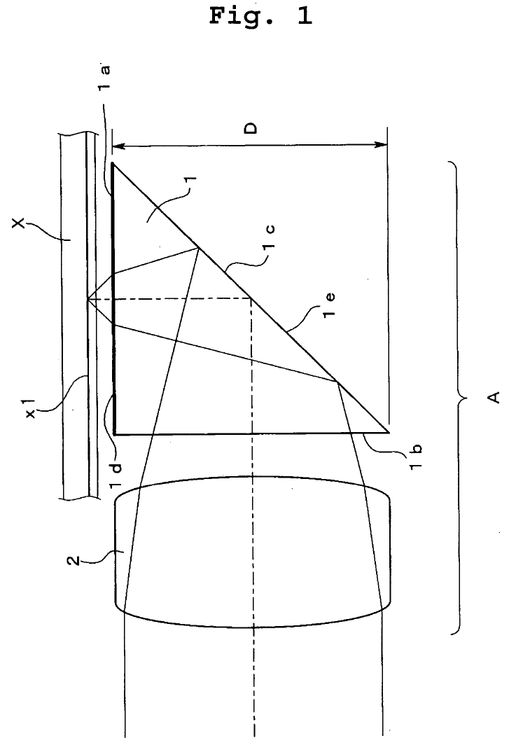

FIG. 1 is a front view showing the construction of a principal part (an object lens system) of an optical pick-up apparatus according to the first embodiment of the present invention. In FIG. 1, reference characters “X” and “A” designate an optical disc and the object lens system, respectively, and reference numerals “1” and “2” designate a triangular prism and a solid lens, respectively. In this first embodiment, the object lens system A includes the triangular prism 1 and the solid lens 2.

The optical disc X is an optical recording medium. Information is read from a recording surface x1 using a blue laser light and is recorded onto the recording surface x1. The triangular prism 1 is fabricated by shaping glass in the form of a triangular pillar, whose cross section is set to a right isosceles triangle. The triangular prism 1 constructed as described above is positioned so that one side surface 1a of the two side surfaces 1a and 1b, which constitute the two equal sides of the triangular prism 1 and are orthogonal to each other, faces the optical disc X and the other side surface 1b faces the solid lens 2.

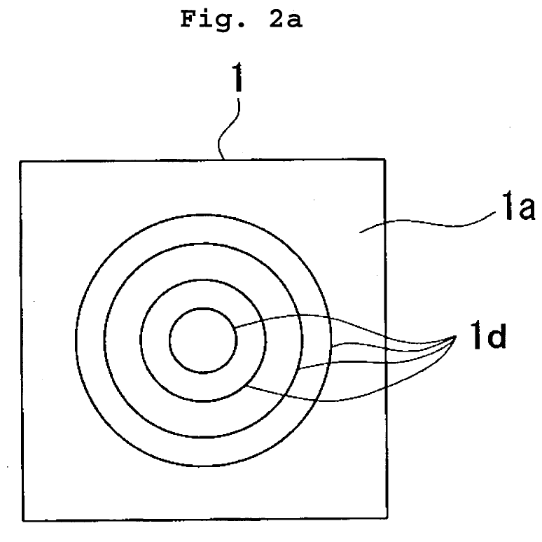

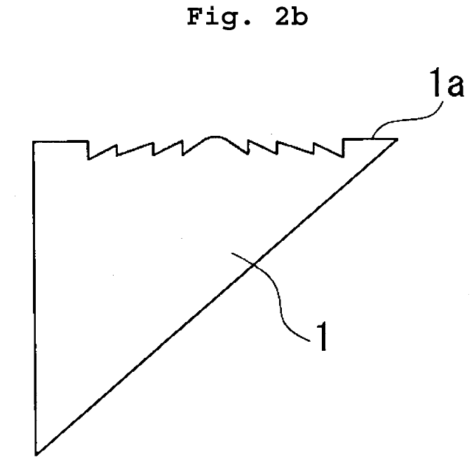

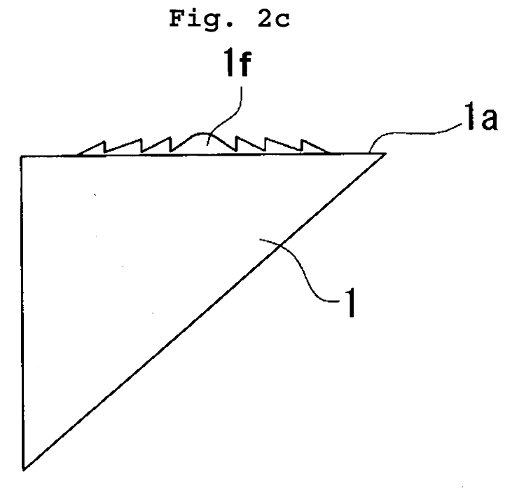

Additionally, a hologram 1d is formed on the one side surface 1a of the triangular prism 1, and a reflecting surface 1e is formed on an inclined surface 1c (direction changing means) of the triangular prism 1. FIGS. 2a to 2c are detailed views of the hologram 1d, in which FIG. 2a is a front view of the hologram 1d and FIGS. 2b and 2c are sectional views of the hologram 1d. As shown in the front view of FIG. 2a, a plurality of concentric circle patterns are arranged in the hologram 1d. As shown in the sectional view of FIG. 2b, the hologram 1d is formed by etching the one side surface 1a. Alternatively, there is shown a method of forming the hologram 1d using a light transparent material if, such as transparent plastic, in the sectional view of FIG. 2c.

Meanwhile, the reflecting surface 1e is formed by depositing metal on the inclined surface 1c, and therefore reflects almost 100% of an irradiated light (blue laser light). The solid lens 2 is a convex lens made of glass, and is arranged to face the front end of the triangular prism 1, that is, the incident side of a blue laser light, with the optical axes thereof being aligned with each other. The object lens system a having the triangular prism 1 and the solid lens 2 has a high Numerical Aperture (NA), for example, 0.85. Additionally, the reflecting surface 1e is formed by depositing a dielectric film on the inclined surface 1c.

Hereinafter, an optical operation of the object lens system A and the optical pick-up apparatus constructed as described above will be described in detail.

In the object lens system A of the present invention, a blue laser light incident as a parallel light in a direction parallel to the optical disc X passes through the solid lens 2, and is incident on the other side surface 1b of the triangular prism 1 (incident surface). Thereafter, the moving direction of the blue laser light is changed to the orthogonal direction thereof through the reflecting surface 1e, and the light is irradiated onto the optical disc X after passing through the one side surface 1a (emitting surface) of the triangular prism 1. In the light path, the blue laser light, which is a parallel light, is collected by the solid lens 2 by a certain amount and more collected by the hologram 1d, thus being focused on the recording surface x1 of the optical disc X. That is, the object lens system A is mounted at a position where the path of the light laser light should be changed from the moving direction to the orthogonal direction through the reflecting surface 1e, thereby collecting the blue laser light and consequently fulfilling collection performance required for a general object lens system.

With the construction of the object lens system A, the triangular prism 1 and the solid lens 2 can be arranged in the direction parallel to the optical disc X, so that the height D of the triangular prism 1 in the direction orthogonal to the optical disc X can be decreased, that is, the optical pick-up apparatus can be miniaturized. Additionally, the triangular prism 1 and the solid lens 2 can be arranged in the direction parallel to the optical disc X, so that it is not necessary to make the sizes of the triangular prism 1 and the solid lens 2 excessively small so as to decrease the height D, and the height D can be decreased using the triangular prism 1 and the solid lens 2 with the practical sizes. In the conventional object lens system constructed using two lenses stacked one on top of the other, the two lenses are stacked in the direction orthogonal to the optical disc X, so that the conventional system is not practical because the two lenses should be miniaturized to decrease the height D.

Additionally, in the object lens system A of the present invention, the blue laser light is collected by the hologram 1d and the solid lens 2 the focal point of which is moved in a different direction depending upon the variation in the wavelength of the blue laser light, so that influence resulting from the variation in the wavelength of the blue laser light can be prevented. Therefore, according to the object lens system A of the present invention, the optical pick-up apparatus can be miniaturized using the triangular prism 1 and the solid lens 2 that are optical parts with practical sizes, while preventing the influence resulting from the variation in the wavelength of the blue laser light irradiated onto the optical disc X.

Additionally, the purpose of the first embodiment is to decrease the number of the optical parts, and the first embodiment employs a construction in which the triangular prism 1 is provided on the one side surface 1a thereof with the hologram 1d and on the inclined surface 1c thereof with the reflecting surface 1e as the direction changing means. However, the hologram 1d and the reflecting surface le may be formed as independent optical parts. Additionally, a convex lens may be formed on the other side surface 1b of the triangular prism 1, so that the solid lens 2 may be removed and, therefore, the number of the optical parts may be reduced.

Second Embodiment

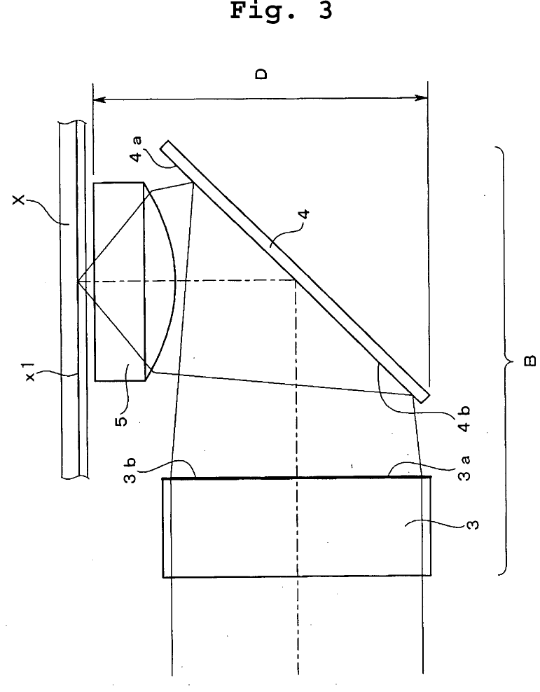

Hereinafter, the second embodiment of the present invention will be described with reference to FIG. 3. Additionally, in the following description, the same reference numerals are used for the same components described in the first embodiment, so that an additional description thereof will be omitted.

FIG. 3 is a front view showing the construction of a principal part (an object lens system) of the optical pick-up apparatus according to the second embodiment of the present invention. In FIG. 3, a reference character “B” designates the object lens system, and reference numerals “3”, “4” and “5” designate a hologram unit, a flat beam splitter (direction changing means) and a thin solid lens, respectively. In the second embodiment, the object lens system B includes the single hologram unit 3, the flat beam splitter 4 and the thin solid lens 5.

The hologram unit 3 includes a hologram 3b similar to the hologram 1d on one side surface 3a of a plate-shaped glass, in which the optical axis thereof is arranged to be parallel to the optical disc X. The flat beam splitter 4 totally reflects a blue laser light incident from the hologram unit 3, and is disposed behind the hologram unit 3 to be inclined to the optical axis of the hologram unit 3 by an angle of 45°, that is, to be inclined to the optical disc X by an angle of 45°. The thin solid lens 5 is a thin convex lens made of glass, and is disposed between the flat beam splitter 4 and the optical disc X.

In the object lens system B constructed as described above, a blue laser light incident as a parallel light in a direction parallel to the optical disc X passes through the hologram unit 3, and is incident on the flat beam splitter 4. Thereafter, the moving direction of the blue laser light is changed to the orthogonal direction thereof through the flat beam splitter 4, and the light is irradiated onto the optical disc X after being incident on the thin solid lens 5 and passing through the thin solid lens 5.

In the light path, the blue laser light, which is a parallel light, is collected by the hologram 3b of the hologram unit 3 by a certain amount and more collected by the thin solid lens 5, thus being focused on the recording surface x1 of the optical disc X.

That is, in the similar manner as the object lens system A in the first embodiment, the object lens system B is constructed in a position where the path of the light laser light should be changed from the moving direction to the orthogonal direction through the flat beam splitter 4, thereby collecting the blue laser light and consequently providing collection performance required to a general object lens system. Additionally, since the path of the light laser light is changed to the orthogonal direction through the flat beam splitter 4, the hologram unit 3 and the flat beam splitter 4 can be arranged in the direction parallel to the optical disc X. Accordingly, the height D of optical parts disposed in the direction orthogonal to the optical disc X can be decreased, that is, the optical pick-up apparatus can be miniaturized.

In this case, since the thin solid lens 5 is disposed between the flat beam splitter 4 and the optical disc X in the object lens system B, the height D is greater than that in the object lens system A of the first embodiment. However, the triangular prism 1 is not used as in the object lens system A as shown in FIG. 3, so that the thin solid lens can be disposed at a position close to the flat beam splitter 4 and, therefore, the thickness of the thin solid lens 5 does not cause the increase of the height D. Accordingly, according to the object lens system B, an optical pick-up apparatus can be miniaturized in comparison to the conventional object lens system constructed using two lenses stacked one on top of the other.

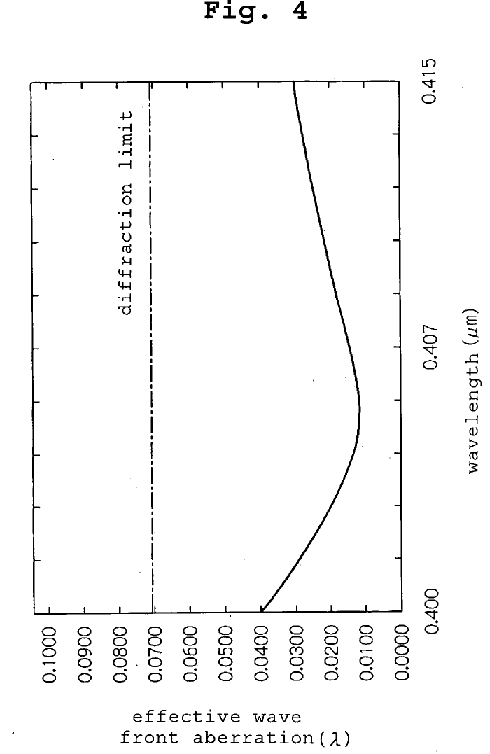

Additionally, according to the object lens system B of the present invention, a wave front aberration caused by the variation in a wavelength can be prevented, compared to the case of using a single lens. FIG. 4 is a characteristic diagram (simulation result) showing the wavelength dependency of the front wave aberration of the object lens system B. As shown in FIG. 4, the wave front aberration much less than a diffraction limit has been obtained in wavelengths of a blue laser light, which range from 400 nm to 415 nm.

Third Embodiment

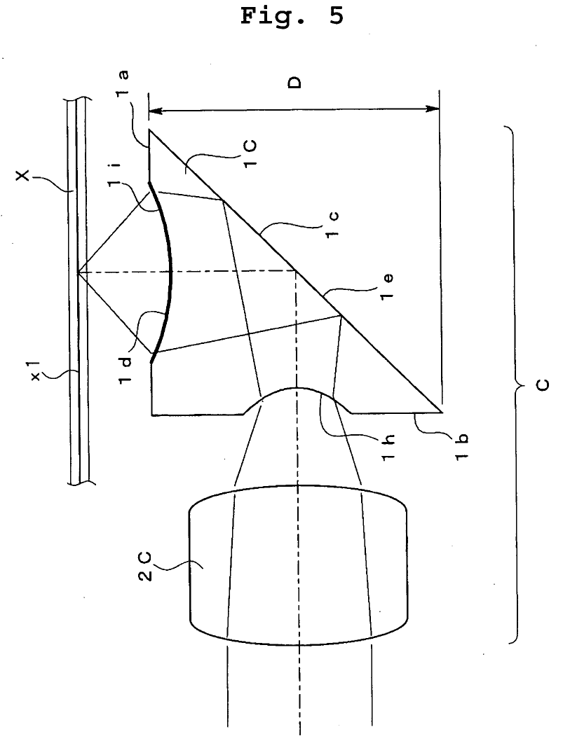

Hereinafter, the third embodiment of the present invention will be described with reference to FIG. 5. Additionally, in the following description, the same reference numerals are used for the same components described in the first embodiment, so that an additional description thereof will be omitted.

FIG. 5 is a front view showing the construction of a principal part (an object lens system) of an optical pick-up apparatus according to the third embodiment of the present invention. As shown in FIG. 5, reference characters “C”, “1C” and “2C” designate the object lens system, a triangular prism and a small-sized solid lens, respectively. In the third embodiment, the object lens system C includes the triangular prism 1C and the small-sized solid lens 2C. That is, the triangular prism 1C is fabricated by forming first and second concave surfaces 1i and 1h on the triangular prism 1 of the first embodiment. That is, the first concave surface 1i is formed on the one side surface 1a of the object lens system C, and the second concave surface 1f is formed on the other side surface 1b of the object lens system C.

The second concave surface 1h is a surface that is formed to have a predetermined curvature in the direction parallel to the optical disc X. The first concave surface 1i is a surface that is formed to have a predetermined curvature in the direction orthogonal to the optical disc X. The second concave surface 1h constructed as described above causes a blue laser light incident from the small-sized solid lens 2C to diverge in the direction orthogonal to the optical disc X. The first concave surface 1i converges the blue laser light that is incident thereon after being caused to diverge by the second concave surface 1h and being reflected by the reflecting surface 1e, and reconstructs the blue laser light to an original form before it is incident on the second concave surface 1h.

The triangular prism 1C constructed as described above is positioned so that the one side surface 1a thereof faces the optical disc X and the other side surface 1b thereof faces the small-sized solid lens 2C. The small-sized solid lens 2C is a convex lens the diameter of which is less than that of the solid lens 2 of the first embodiment.

In the object lens system C constructed as described above, a blue laser light incident as a parallel light in the direction parallel to the optical disc X passes through the small-sized solid lens 2C, and is incident on the second concave surface 1h of the triangular prism 1C. Thereafter, the moving direction of the blue laser light is changed to the orthogonal direction thereof through the reflecting surface 1e, and the light is irradiated onto the optical disc X after passing through the first concave surface 1i of the triangular prism 1C. In the light path, the blue laser light, which is the parallel light, is collected by the small-sized solid lens 2C by a certain amount and more collected by the hologram 1d, thus providing collection performance required for a general object lens system.

Additionally, the triangular prism 1C and the small-sized solid lens 2C can be arranged in the direction parallel to the optical disc X, so that the height D of the triangular prism D in the direction orthogonal to the optical disc X can be decreased, that is, the optical pick-up apparatus can be miniaturized.

Additionally, the blue laser light is caused to diverge in the direction orthogonal to the optical disc X through the second concave surface 1h, and then is reconstructed to the original form through the first concave surface 1. Accordingly, the blue laser light incident on the small-sized solid lens 2C may be an elliptical-shaped beam, which is distorted in the direction orthogonal to the optical disc X, other than a round-shaped beam, so that the height D according to the object lens system C of third embodiment can be reduced by the distorted amount of the blue laser light, compared to that of the object lens system A of the first embodiment.

As described above, the present invention provides an object lens system arranged to face an optical disc, collect a light and irradiate the light onto the optical disc, which includes a direction changing means for changing the moving direction of an incident light to the orthogonal direction thereof and irradiating it onto the optical disc, a hologram or a solid lens disposed between the direction changing means and the optical disc, and a solid lens or a hologram disposed in front of the direction changing means. Accordingly, an optical pick-up apparatus can be miniaturized while preventing influence resulting from a variation in the wavelength of a blue laser light irradiated onto an optical disc through the use of optical parts with practical sizes, without miniaturizing the optical parts of the object lens system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An object lens system arranged to face an optical disc, collect light and irradiate the light onto the optical disc, comprising:
a direction changing means for changing a moving direction of incident light to an orthogonal direction thereof and emitting it onto the optical disc, the direction changing means being provided with a hologram on one side surface thereof; and
a solid lens disposed in front of an incident surface of the direction changing means.

2. An object lens system of claim 1, further comprising an optical pick-up apparatus capable of emitting light onto the object lens system and detecting the intensity of reflected light obtained by an optical disc.

3. An object lens system according to claim 1, wherein:
the direction changing means is a triangular prism that has an incident surface, a reflecting surface and an emitting surface; and
the hologram is formed on the emitting surface of the triangular prism.

4. An object lens system of claim 3, further comprising an optical pick-up apparatus to emit light onto the object lens system and detect the intensity of reflected light obtained by an optical disc.

5. An object lens system according to claim 3, wherein:
the triangular prism is provided on the incident surface thereof with a second concave surface that causes the incident light to diverge in a direction orthogonal to the optical disc;
the triangular prism is provided on the emitting surface thereof with a first concave surface that converges the diverging incident light; and
the triangular prism is provided on the first concave surface thereof with the hologram.

6. The object lens system of claim 5, further comprising an optical pick-up apparatus to emit light onto the object lens system and detect the intensity of reflected light obtained by an optical disc.

7. An object lens system according to claim 1, wherein the solid lens is a convex lens that is disposed in front of the incident surface of the direction changing means.

8. An object lens system according to claim 7, further comprising an optical pick-up apparatus to emit light onto the object lens system and detect the intensity of reflected light obtained by an optical disc.

9. An object lens system according to claim 1, wherein the hologram is formed of light transparent materials.

10. An object lens system according to claim 9, further comprising an optical pick-up apparatus to emit light onto the object lens system and detect the intensity of reflected light obtained by an optical disc.

11. An object lens system arranged to face an optical disc, collect light and irradiate the light onto the optical disc, comprising:
a direction changing means for changing a moving direction of incident light to an orthogonal direction thereof and emitting it onto the optical disc;
a hologram unit disposed in front of the direction changing means and provided with a hologram; and
a solid lens disposed between the direction changing means and the optical disc.

12. An object lens system according to claim 11, further comprising an optical pick-up apparatus to emit light onto the object lens system and detect the intensity of reflected light obtained by an optical disc.

13. An object lens system according to claim 11, wherein the direction changing means is a beam splitter.

14. An object lens system according to claim 13, further comprising an optical pick-up apparatus to emit light onto the object lens system and detect the intensity of reflected light obtained by an optical disc.

15. An object lens system according to claim 11, wherein the hologram is formed of light transparent materials.

16. An object lens system according to claim 15, further comprising an optical pick-up apparatus provided with the object lens system of claim 15 to emit light onto the object lens system and detect the intensity of reflected light obtained by an optical disc.
